(19) United States
(12) Patent Application Publication
(10) Pub. No.: US 2011/0218791 A1
(43) Pub. Date: Sep. 8, 2011

(54) System for Simulating Processor Power Consumption and Method of the Same

(76) Inventors: Chien-Min LEE, Hsin Chu City (TW); Chen-Kang Lo, Taipei City (TW); Meng-Huan Wu, Hsinchu City (TW); Ren-Song Tsay, Jhubei City (TW)

(21) Appl. No.: 12/716,446

(22) Filed: Mar. 3, 2010

(51) Int. Cl. G06G 7/62

(52) U.S. Cl. 703/16

(57) ABSTRACT

The present invention provides a method for simulating processor power consumption, the method comprises: simulating a simulated processor; utilizing a power analysis model to analyze the simulated processor's execution of at least one fragment of a program, for generating power analysis of a plurality of basic blocks of the at least one fragment; computing at least one power correction factor between the plurality of basic block; utilizing a processing apparatus to generate a simulation model with power annotation based on the power analysis and the at least one power correction factor; and predicting power consumption of the simulated processor based on the simulation model with power annotation.

### FIELD OF THE INVENTION

The present invention is generally related to the field of processor simulation and, more particularly, to a two-phase processor power consumption simulation method and a system for implementing the method.

### DESCRIPTION OF THE PRIOR ART

Power wall has become a critical issue for modern electronic system designs, as exemplified by the insistently reduced power budget and ever more functional components of portable electronic devices. Therefore, reducing the power consumptions of the electric components therein is one of the necessary approaches for achieving the above purpose. The power consumption of the processor, generally referring to CPU, logical chip, or other processing apparatus with processing ability, is emphasized. The industries are attempted to modify the circuits within the processor to lower the power consumption of the processor.

In early days, the system designer needs to implement the whole processor for testing the power consumption. If the result of the test does not meet the anticipation, the system designer will modify the layout of the components or the architecture within the processor again and again, for providing a processor with lower power consumption. However, every time the system designer modifies the processor, a big amount of additional costs is accompanied. Consequently, a method for simulating the execution of a processor has been provided in prior arts, for providing the prediction of the power consumption before the finish of the processor's implementation. Whereby, the power consumption result may be acquired during the design stage, for facilitating giving further modifications as early as possible. A fast and accurate system-level power estimation tool is essential for effective design space exploration. However, the system-level processor power simulation tool can not provide both fast and accurate result of simulation.

Processor power estimation has been studied for many years. For example, an instruction level power analysis (ILPA) model has been provided. However, it cannot achieve pipeline-accurate power estimation due to the lack of detailed pipeline power information.

For better accuracy, several works have proposed an architecture level power analysis (ALPA) approach, which provides fine-grained simulation model for detailed simulation. However, the simulation speed is sacrificed. The simulation speed of the architecture level is usually more than 1,000 times slower than ILPA.

For faster power consumption evaluation of peripheral cores, Givargis et al. has proposed a trace-driven simulation technique. The main idea is similar to ILPA, i.e., they break the functionality of each core into several instructions and then characterize the power consumption of each instruction. For example, Reset, Enable_tx, Enable_rx, Send, and Receive are the selected instructions for universal asynchronous receiver and transmitter (UART). The problem with this approach is that instruction traces are generated by functional models without timing information. Hence, timing-sensitive events, such as interrupts, may result in incorrect results.

All in all, the dilemma is that a fine-grained model is required for accurate power estimation; however, the simulation speed will be conceivably poor. On the other hand, coarse-grained simulation model, although fast, generates insufficient states to support accurate power calculation.

Consequently, the embodiments of the present invention provide a processor power consumption simulation method and a system of the same, for amending the above-mentioned conditions.

### SUMMARY OF THE INVENTION

In one aspect of the embodiments of the present invention, a method for simulating processor power consumption is provided. The method comprises: simulating a simulated processor by a simulation module; utilizing a power analysis model to analyze the simulated processor's execution of at least one fragment of a program, for generating power analysis of a plurality of basic blocks of the at least one fragment by a analysis module; computing at least one power correction factor between the plurality of basic blocks by a correction module; utilizing a processing apparatus to generate a simulation model with power annotation based on the power analysis and the at least one power correction factor by a annotation module; and predicting power consumption of the simulated processor based on the simulation model with power annotation by a prediction module.

In another aspect of the embodiments of the present invention, a storage medium readable by a processor, storing instructions executable by the processor to perform a method for simulating processor power consumption is provided. The method comprises the above-mentioned steps.

In still another aspect of the embodiments of the present invention, a software product tangibly embedded in a computer readable storage medium for simulating processor power consumption is provided. The software product comprises instructions operable to cause a processing apparatus to perform the above-mentioned steps.

In further another aspect of the embodiments of the present invention, a system for simulating processor power consumption is provided. The system comprises: a control module; a simulation module, coupled to the control module, for simulating a simulated processor; an analysis module, coupled to the control module, for utilizing a power analysis model to analyze the simulated processor's execution of at least one fragment of a program and generate power analysis of a plurality of basic blocks of the at least one fragment; a correction module, coupled to the control module, for computing at least one power correction factor between the plurality of basic blocks; an annotation module, coupled to the control module, for generating a simulation model with power annotation based on the power analysis and the at least one power correction factor; and a prediction module, coupled to the control module, for predicting power consumption of the simulated processor based on the simulation model with power annotation.

Utilizing the method and system provided by the embodiments of the present invention, the electronic system designers may trace the processor power consumption issue as soon as possible when executing software, which is beneficial for effective design space exploration.

### BRIEF DESCRIPTION OF THE DRAWINGS

FIG. 1 illustrates an exemplary hardware arrangement for implementing the embodiments of the present invention;

FIG. 2 illustrates a system for simulating processor power consumption according to the embodiments of the present invention;

FIG. 3 illustrates a flow diagram of a method for simulating processor power consumption according to the embodiments of the present invention;

FIG. 4 illustrates a more detailed flow diagram of a method for simulating processor power consumption according to the embodiments of the present invention;

FIG. 5 illustrates another detailed flow diagram of a method for simulating processor power consumption according to the embodiments of the present invention;

FIGS. 6A-6C illustrate an exemplary target program according to the embodiments of the present invention;

FIGS. 7A-7C illustrate a pipeline status according to the embodiments of the present invention;

FIG. 8 illustrates a performance comparison diagram according to the embodiments of the present invention; and

FIGS. 9-11 illustrate accuracy comparison diagrams according to the embodiments of the present invention.

### DESCRIPTION OF THE PREFERRED EMBODIMENT

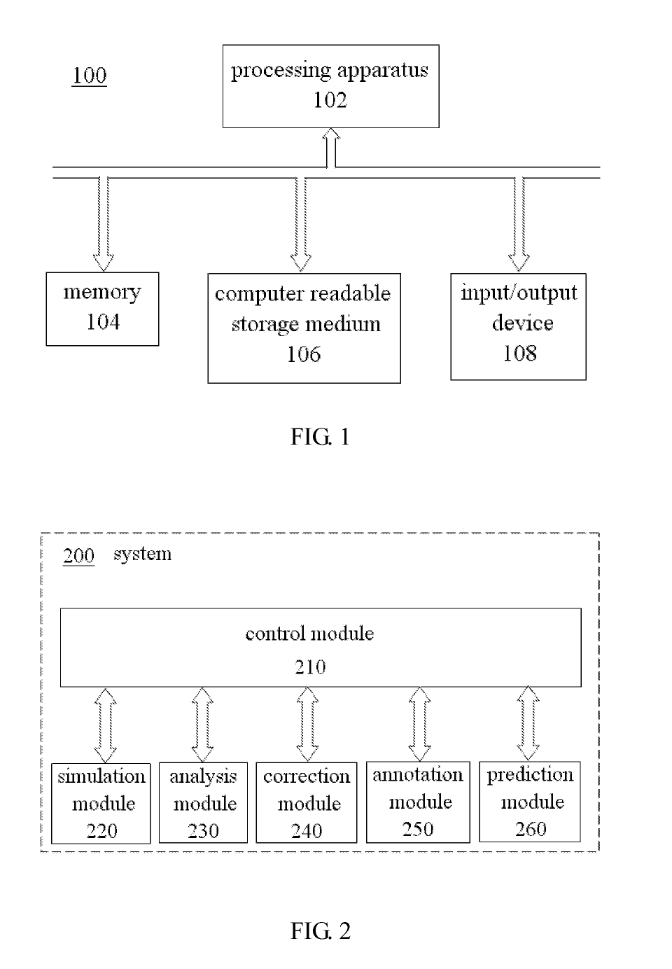

In the embodiments of the present invention, a method for simulating processor power consumption is provided. For achieving the method, a system for simulating processor power consumption is also provided in the embodiments of the present invention. A programmable computer can be utilized to implement the system. For example, a hardware apparatus for implementing an embodiment of the present invention is shown in FIG. 1. The apparatus comprises, but not limited to, a processing apparatus 102, a memory 104, a computer readable storage medium 106, an input/output device 108, etc. They may be connected together via a bus or other electric connecting ways. In the preferred embodiments, the apparatus can be implemented, but not limited to, by a server or work station level computer, wherein the processing apparatus 102 may be Intel Xeon 3.4 GHz quad-core CPU or other CPU, system on chip, or other processing apparatus having computing ability. The memory 104 may be 2 GB or more. In general, the embodiments of the present invention can be implemented by a general personal computer, a work station level computer, a server level computer, a notebook computer, or other apparatuses, such as system on chips, which have computing ability. For implementing the embodiments, the above-mentioned apparatus, such as a computer, should be programmed specifically to comprise a software program for specific purpose. The software program may be downloaded from internet as a program product or alternatively stored on the computer readable storage medium 106 for the processing apparatus 102 to read the instructions stored wherein. With the memory 104, the input/output device 108 and/or other conventional components not shown in FIG. 1, the system for simulating processor power consumption and the method of the same can be performed according to the embodiments of the present invention. In general, the computer readable storage medium 106 and/or the memory 104 may selectively store software, such as operating system, application program, programming language and corresponding compiler, etc. Further, it may comprise firmware and/or other essential components. Furthermore, the computer readable storage medium 106 may comprise, but not limited to, floppy disc, optic disc, read only optical disc, magnetic disc, read only memory (ROM), random access memory (RAM), erasable programmable read only memory (EPROM), electrically erasable programmable read only memory (EEPROM), magnetic card, optical card, flash memory, or other medium (or machine readable medium) suitable for storing electric instructions.

FIG. 2 illustrates a system 200 for simulating processor power consumption according to the embodiments of the present invention. The system 200 comprises a control module 210; a simulation module 220, coupled to the control module 210, for simulating a simulated processor; an analysis module 230, coupled to the control module 210, for utilizing a power analysis model to analyze the simulated processor's execution of at least one fragment of a program and generate power analysis of a plurality of basic blocks of the at least one fragment; a correction module 240, coupled to the control module 210, for computing at least one power correction factor between the plurality of basic blocks; an annotation module 250, coupled to the control module 210, for generating a simulation model with power annotation based on the power analysis and the at least one power correction factor; and a prediction module 260, coupled to the control module 210, for predicting power consumption of the simulated processor based on the simulation model with power annotation.

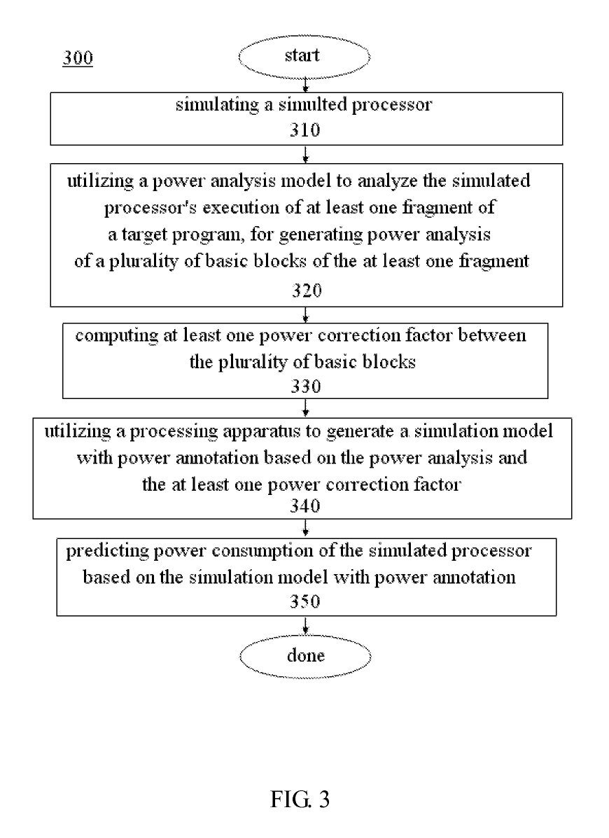

Utilizing the system 200 mentioned above, a method 300 for simulating processor power consumption can be provided, as shown in FIG. 3. The method 300 comprises: at step 310, simulating a simulated processor by the simulation module 220; at step 320, utilizing a power analysis model to analyze the simulated processor's execution of at least one fragment of a target program, for generating power analysis of a plurality of basic blocks of the at least one fragment by the analysis module 230; at step 330, computing at least one power correction factor between the plurality of basic blocks by a correction module 240; at step 340, utilizing a processing apparatus to generate a simulation model with power annotation based on the power analysis and the at least one power correction factor by a annotation module 250; and in step 350, predicting power consumption of the simulated processor based on the simulation model with power annotation by a prediction module 260. More specifically, the steps mentioned above are performed by utilizing the processing apparatus 102 to operate the control module 210 to transfer/receive instructions to other module 220-260 for individual work. The temporary or permanent data generated by each of the modules' executing each of the steps may be stored in the memory 104 or the computer readable storage medium 106, for facilitating other module executing other steps or storing the data.

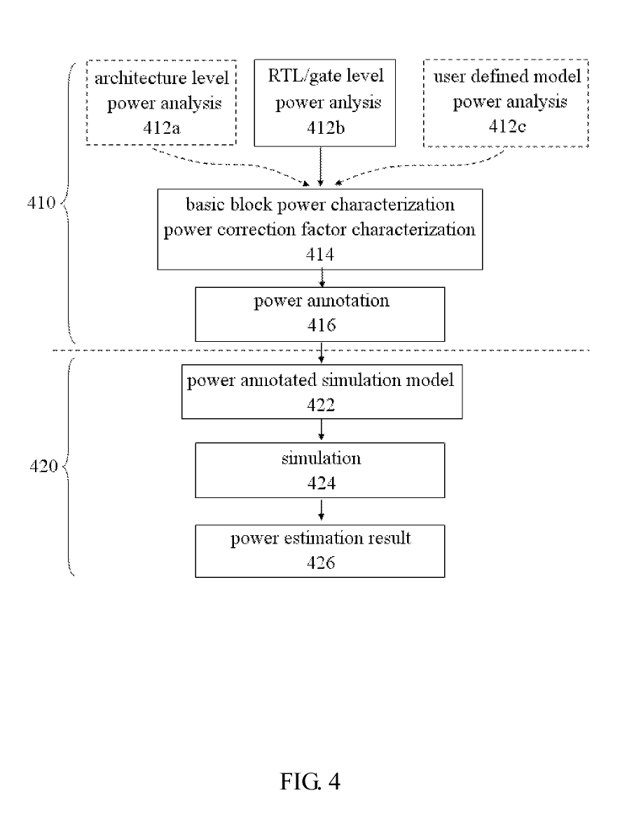

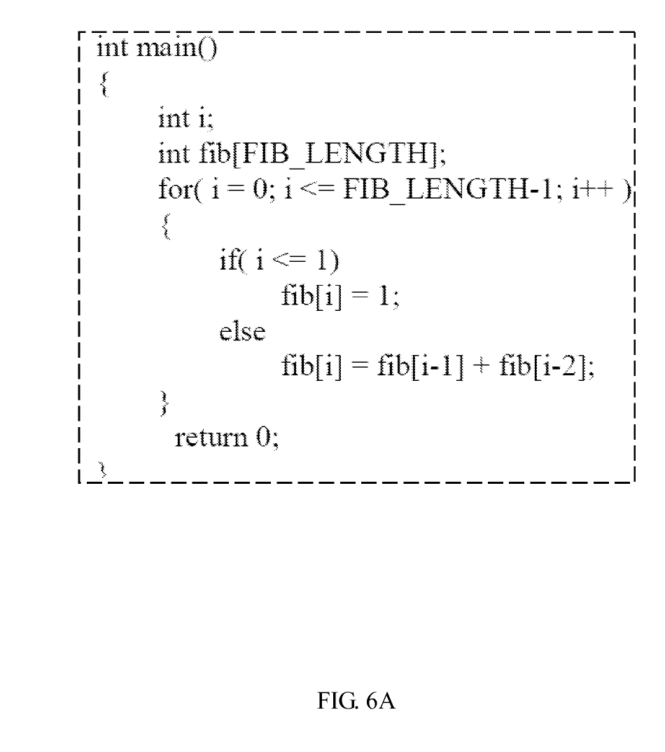

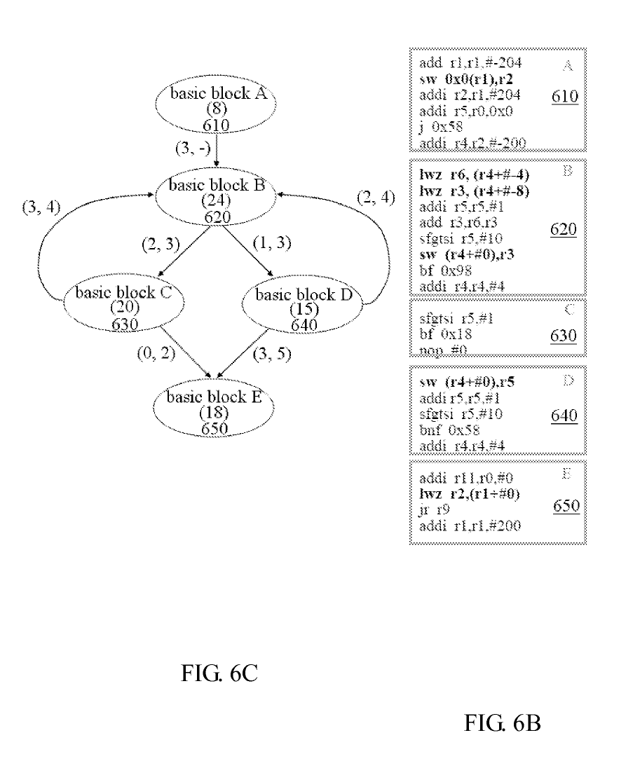

FIG. 4 illustrates the more detailed flow diagram of a method for simulating processor power consumption according to the embodiments of the present invention. Generally, the steps of the method 300 can be sorted as two phases, i.e. the pre-characterization phase and the simulation phase. The “pre-characterization phase” used herein means acquiring power analysis of the basic blocks and computing power correction factors before performing simulation phase 420, i.e. executing step 414, and performing power annotation in step 416. For more detailed explanation, please refer to FIGS. 6A-6C and the related description. In pre-characterization phase 410, one of the several analysis approaches may be utilized, such as architecture level power analysis (ALPA) 412a, register transfer level/gate level power analysis 412b or other user defined mode power analysis 412c. In general, a relative more accurate power model is utilized in this phase, for generating relative more accurate power analysis of the plurality of basic blocks. The “more accurate” used herein is generally contrast to the “more coarse” simulation model, such as the instruction level power analysis model. Therefore, it is not limited to any specific power model. As long as a power analysis model which is relative more accurate than the model used in the simulation phase 420 is utilized in the pre-characterization phase 410, the effect can be observed which is more accurate than using a single coarse simulation model and faster than using a single accurate power analysis model. Then, power annotation is performed in step 416, for annotating the power analysis of the basic blocks and the power correction factor(s) to the simulation model and getting a simulation model with power annotation. For more detailed explanation of the power annotation, please refer to FIGS. 6A-6C and the related description. During the simulation phase 420, step 424 is performed utilizing the simulation model with power annotation, and the power predicting result is acquired in step 426 by the predicting model 260. In preferred embodiments, a compiled simulation technique is utilized in step 424, for de-compiling the target binary codes to C codes.

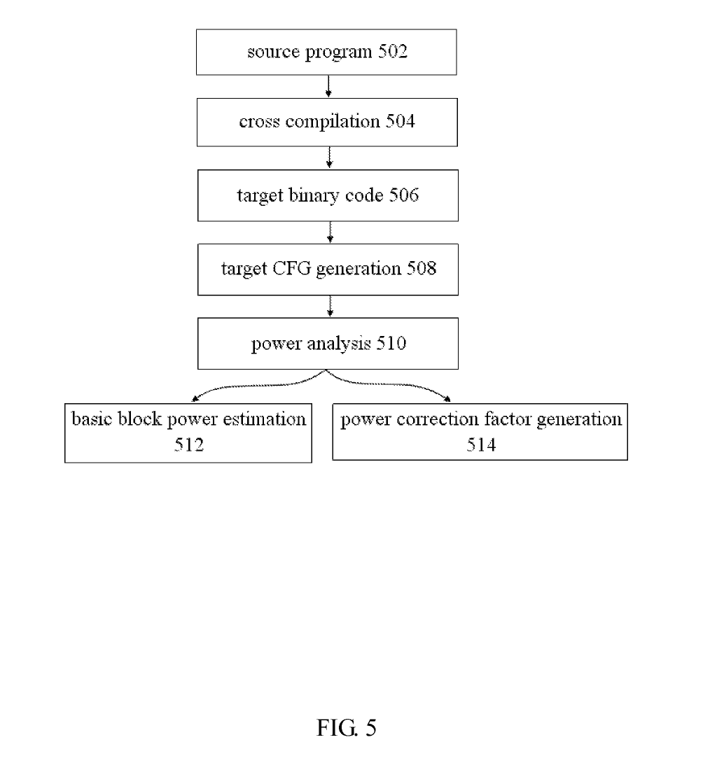

FIG. 5 illustrates the more detailed flow diagram of a method for simulating processor power consumption. In step 502, receiving a source program/target program; in step 504, utilizing a cross compiler to cross compiling; in step 506, generating target binary codes; in step 508, generating target control flow graph (CFG); and in step 510, utilizing a relative more accurate power analysis model (such as a gate level power analysis model, such as PrimePower) to calculate the power consumption of each of the basic blocks. The power analysis in step 510 generally comprises the generation of the power analysis of the basic blocks (step 512) and the generation of the power correction factor(s) (step 514). In this embodiment, the above steps are performed by the analysis model 230. One of the purposes of utilizing the cross compiler is for working at different working environment. One of the purposes of utilizing binary codes is for acquiring more accurate analysis. The power analysis information mentioned above may selectively stored in a database coupled to the control model 210.

FIG. 6A-6C illustrate an exemplary control flow graph (CFG) according to the embodiment of the present invention. In this embodiment, Fibonacci series is utilized as the target program. Its source code is shown as FIG. 6A. Based on the observation that most program segments are repeatedly executed (for example, the loop structure) and the power consumption of each program segment is nearly fixed, the fragment or the structure of the target program (for example, but not limited to, the Fibonacci series) is recognized for generating a CFG in the embodiments of the present invention, as the target compiled code shown in FIG. 6B and the corresponding CFG shown in FIG. 6C. On the other hand, the effects of, for example, branch, cache, and pipeline status will influence the value of power consumption, such as the flush, stall and freeze effects. Therefore, the power correction factor (PCF) is utilized for amending these effects, and it is performed by the correction module 240. Further, examples of branch instructions are branch, jump, call and return, etc.

For example, FIG. 6C shows a CFG with power annotation, wherein the number inside each node represents the power consumption of each basic blocks A 610-E 650, and the pair of numbers inside the brackets near each directed link represents the inter-basic block power correction factors. Note that for easy illustration purpose, the numbers presented here are picked as representative integer numbers rather than the real power consumption values. These are performed by the annotation module 240. Further, the step of power annotation mentioned above can be deemed to utilize a power annotation with pre-characterization (PAPC) algorithm. The input of this algorithm is a CFG or an equation G=(V, E) which represents the program control flow structure, and the output is a power annotated CFG. The algorithm works by traversing CFG and characterizing each basic block and each edge's power correction factor. In the preferred embodiments, The PAPC follows breadth fist search (BFS) algorithm and traverses the program CFG from the start node to the end node. During traversing, if any un-visited node or edge is encountered, power characterization is performed. The exemplary codes of the PAPC are shown as follows:

| | |
|---|---|
| 1. | Input: CFG G(V, E) with start node s |
| 2. | Output: a power annotated CFG |
| 3. | Q: vertex queue={s} |
| 4. | PCF: power correction factor |
| 5. | BB: basic block |
| 6. | Begin |
| 7. | while Q is not empty do |
| 8. | for each node u in Q do |
| 9. | for all edge (u, v) in E do |
| 10. | if node u contains a branch instruction |
| 11. | - calculate the branch PCFs |
| 12. | - instrument conditional codes for determining |
| | which PCF should be used at runtime |
| 13. | else |
| 14. | - calculate the inter-BB PCF of (u, v) |
| 15. | if node v is un-visited then |
| 16. | - calculate the intra-BB power consumption of v |
| 17. | if node v contains load/store instructions |
| 18. | - calculate the cache miss penalty PCF |
| 19. | end if // node v contains load/store instructions |
| 20. | - mark v visited |
| 21. | - inset v into Q |
| 22. | end if // node v is un-visited |
| 23. | end of for // all edge (u, v) |
| 24. | end of for // each node u in Q |
| 25. | end of while |
| 26. | End |

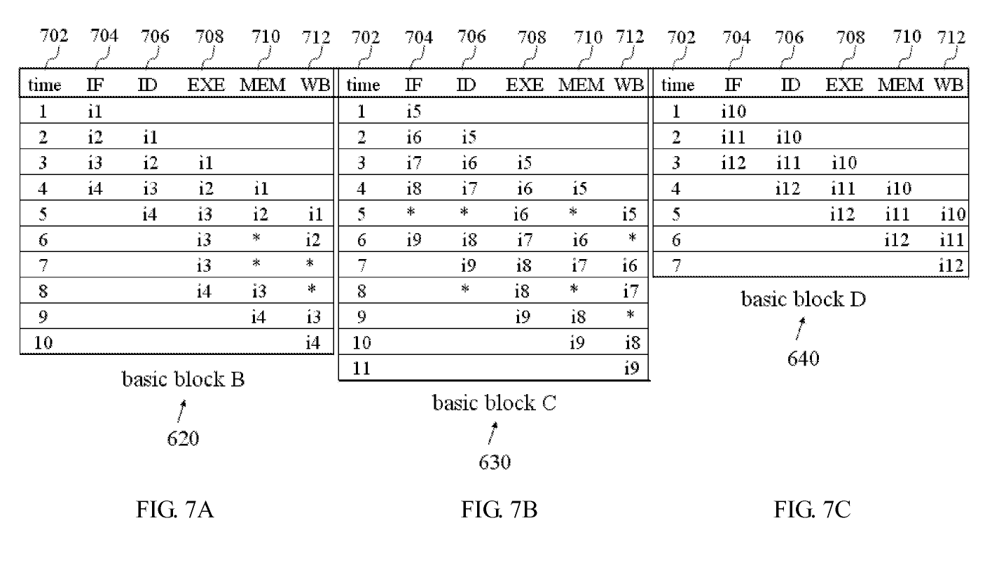

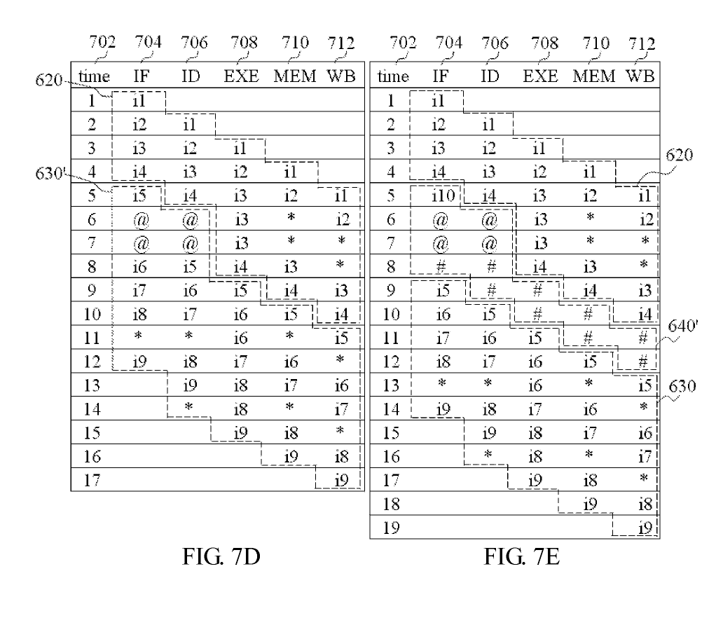

In FIGS. 6B-6C, for example, the basic block B 620 may comprise a branch instruction and may branch to either basic block C 630 or D 640. Independent of the taken branch, there are only two possible combinations: either the branch is predicted and taken or it is mis-predicted and taken. Hence, on each directed edge, two numbers are utilized to indicate the correction values for predicted result and mis-predicted result correspondingly. For more detailed explanation, please refer to FIGS. 7A-7E and the related description.

FIG. 7A shows one example of the pipeline status of the basic block B 620, wherein the columns 702-712 represent each stage of the five-stage structure, which represents instruction fetch (IF) 702, instruction decode (ID) 704, execute (EXE) 706, memory (MEM) 708, and write back (WB) 710. It should be appreciated that the five-stage structure is utilized for purpose of being thoroughly understood. Hence, it can apply to more complicated structure with the same principle. In one example, the basic block B 620 in FIG. 7A may consume x units of power and its next consecutive basic block C 630, shown in FIG. 7B, may consume y units of power. Note that the blank areas on the upper and the lower triangles represent no operations (NOPs), inserted by complier, which still consume static power. Exemplified in FIG. 7D is the combined pipeline status of consecutive execution of the basic block B 620 and C 630, consuming z units of power, from a predicted and taken branch. The overlap of consecutive basic blocks often introduce additional pipeline stalls, marked “g” in FIG. 7D, which consume extra power. However, since the total blank areas are reduced, the final power consumption may in fact be less. In other words, the total power consumption z of the consecutive execution in general is not equal to the simple summation of the power consumptions of the two basic blocks, i.e. z!=x+y. The difference z−(x+y) can be pre-computed by the correction module 240 and is noted as one of the two correction values to be used for runtime simulation correction. Further, the basic block C 630 comprising pipeline stall instruction is represented as 630′.

In the other hand, if the target branch is mis-predicted, the pipeline has to be flushed to clean up pre-fetched instructions, shown in FIG. 7E, where the character “#” represents pipeline flush and the symbol “*” represents pipeline stall and waiting for progressing at that stage. For either case, the power estimation result demands power correction. To further explain the case of mis-predicted but taken case, it is assumed that the basic block D 640 is as shown in FIG. 7C and the branch prediction at the end of basic block B 620 predicts basic block D 640 and starts pre-fetching of D's instruction, “i10”, as shown in FIG. 7E. Since the taken edge is actually basic block C 630, after a short stall, the pre-fetched instructions are flushed as those marked “#”. Further, the portion of the basic block D 640 comprising pipeline flush instruction is presented as 640′.

In one embodiment of the present invention, when executed independently, the basic block B 620 may consume 24 units of power, the basic block C 630 may consume 20 units of power, and the basic block D 640 may consume 15 units of power. Basic block B 620 may comprise a branch instruction “i4”. The consecutive execution of predicted basic block B 620 to C 630 may cost additional 2 units of power while the mis-predicted B to C branch costs additional 3 units of power. Therefore, the power correction factor on the branch is (2, 3), as shown in FIG. 4B. In the embodiments of the present invention, the above-mentioned correction factors are generated by utilizing the correction module 240, and further to annotate by utilizing the annotation module 250.

The implementation of the other correction factors shown in FIG. 6B should be understood with the same principle. For the special case of basic block A 610 in FIG. 6B, there is only one outgoing edge to the basic block B 620 and it is always a predicted and taken edge. In one embodiment of the present invention, the combing of basic block A 610 and B 620 costs additional 3 units of power, then the power correction factor on edge A to B is marked as (3, −), where “−” means don't care, since the mis-predicted and taken case will never happen here.

Likewise, extra powers are needed for the pipeline stalls or freezes caused by cache miss. In general, the pipeline behaves differently when data/instruction cache misses or hits, depending on the pipeline architecture. In some embodiments of the present invention, the cache miss penalty power correction is also considered. Take the OR1200 RISC processor as an example. When an instruction cache miss occurs and a load/store instruction is progressing at execution stage with data cache hit, then an NOP (i.e. pipeline stall) is inserted to keep pipeline progressing; in contrast, when a data cache miss occurs, the pipeline will be frozen. Nevertheless, only at runtime whether it will cause pipeline stall or freeze and affect processor power consumption. Yet, in practice the per-cycle power consumption of stalling or freezing can be pre-characterized. Hence, once the number of cycles stalled or frozen is known at runtime, the additional power consumption caused by cache misses can easily be calculated. In the embodiments of the present invention, the above-mentioned extra power consumption is acquired by utilizing the correction module 240.

The determine the number of stalled cycles due to cache miss latency, many models can be applied for this purpose. For example, CACTI is a possible memory model, and the counter approach proposed by Atitallah et al. is another possibility. The cycle count accurate memory model proposed by Yi-Len Lo et al. is still another candidate, which is utilized in the preferred embodiments of the present invention. Further, counting cache access latency dynamically is also utilized. Thus, the per cycle energy consumption of freeze and stall may be pre-characterized and the number of stall and freeze cycles at runtime may be counted.

In one embodiment of the present invention, an open source 32-bit RISC processor OR1200 is adopted, a gate-level power estimation tool PrimePower is used for power characterization, and a static compilation technique is adopted for instruction set simulation (ISS) implementation. The test cases of the benchmark are mainly from OpenRISC project at OpenCores organization, and tested on a host machine with Intel Xeon 3.4 GHz quad-core and 2 GB RAM.

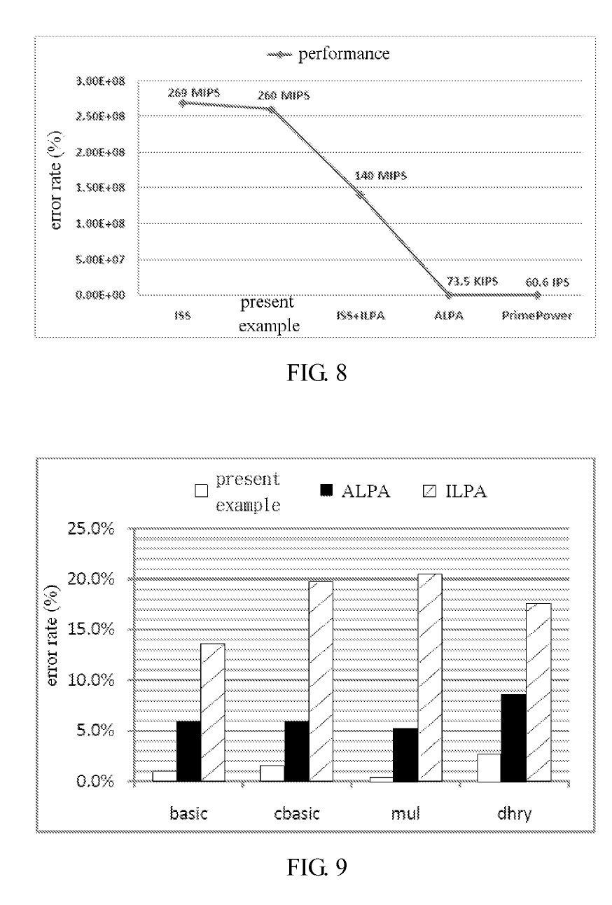

FIG. 8 shows a performance comparison diagram comprising functional ISS without power information, the present example, ISS with instruction level power model (ISS+ILPA), architectural level power model (ALPA), and PrimePower. The experimental results show that the example provided in this embodiment runs at almost the same speed as the functional ISS and is obviously greater than other three. Further, the example provides more power analysis than the functional ISS.

For accuracy comparison, in another embodiment of the present invention, the benchmark test with the example, ALPA, and ILPA on the same set of test cases. The test cases comprise “basic”, “cbasic”, “mul”, and “dhry”. As shown in FIG. 9, the error rate of the example is three to ten times less than ALPA and the simulation speed of the example is four order faster than ALPA, as shown in FIG. 8. The error rate of ILPA is more than 13% because of the lack of pipeline information as mentioned earlier.

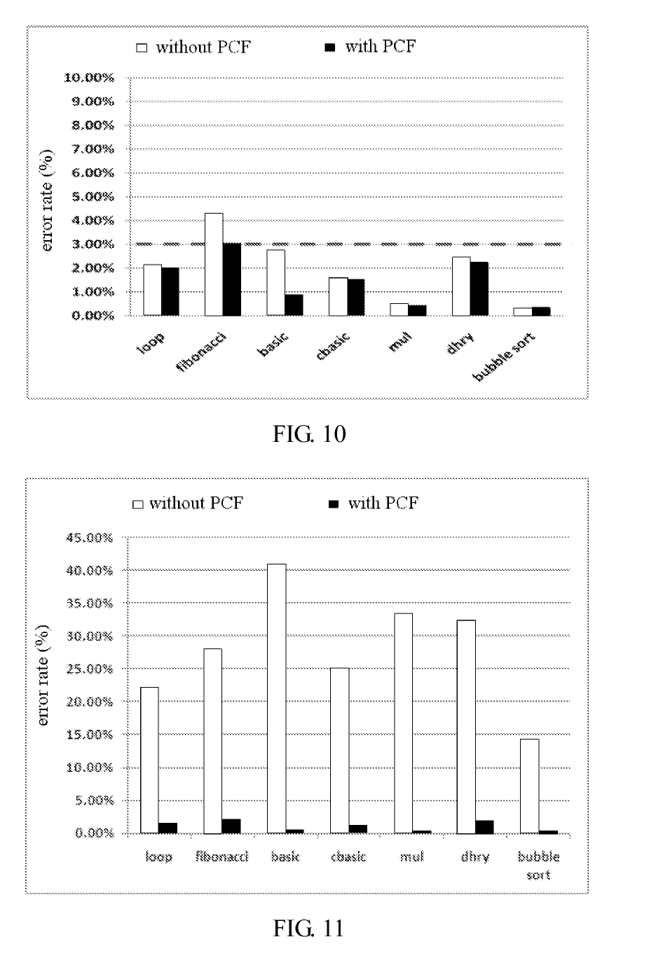

Using the detailed gate level power analysis tool PrimePower as a golden reference, further comparison of the examples with and without power correction factors considering ideal cache is provided, as shown in FIG. 10, for proving the effect provided by the power correction factor(s). As shown in FIG. 10, the test cases comprises “loop”, “Fibonacci series”, “basic”, “cbasic”, “mul”, “dhry”, and “bubble sort”. It can be observed that the error rates of the examples with PCF are generally lower than that of the ones without PCF.

In another embodiment of the present invention, a direct mapped cache is adopted for considering cache misses. In this embodiment, it can be observed that the average error rate is more than 14% without cache miss corrections. Noticeably, the error rate of the basic test case is higher than others. This is because it contains no loop structure and hence caches misses occur frequently.

In some embodiments of the present invention, a storage medium readable by a processor, storing instructions executable by the processor to perform a method for simulating processor power consumption is provided. The method comprises the above-mentioned steps.

In some other embodiments of the present invention, a software product tangibly embedded in a computer readable storage medium for simulating processor power consumption is provided. The software product comprises instructions operable to cause a processing apparatus to perform a method for simulating processor power consumption. The method comprises the above-mentioned steps.

One advantage of the embodiments of the present invention is that a two-phase simulation method is utilized. A relative more accurate power analysis model, such as a gate level power analysis model, is utilized to analyze one fragment of a target program, for acquiring the power analysis of its basic blocks and the power correction factor between the basic blocks. A simulation model with relative faster simulation speed is then utilized to simulate with the mentioned power analysis and the power correction factor, whereby the problems corresponding to low simulation speed of a fine-grained power analysis model and the poor accuracy of the coarse-grained simulation model existed in the prior art can thus be amended.

Another advantage of the embodiments of the present invention is that effects of pipeline, branch, and/or cache miss are considered. Thus, the method and system provided by the present invention can apply to processor simulation model with more complicated architecture. The improvement of the embodiments of the present invention is not obvious to the prior art and the effect is supported by the experimental data.

Further another advantage of the embodiment of the present invention is that the fragments of a program, such as loop structures, which are repeated frequently can be fast computed utilizing the model with power annotation, and thus further detailed power analysis can be avoided without needs of time-consuming re-calculation as in the conventional power simulators.

Through the detailed description above, the spirit and features should be thoroughly understood by the ordinary skill in the art. However, the details in the embodiments are only for examples and explanation. The ordinary skill in the art may make any modifications according to the teaching and suggestion of the embodiments of the present invention, for meeting the various situations, and they should be viewed as in the scope of the present invention without departing the spirit of the present invention. The scope of the present invention should be defined by the following claims and the equivalents.

What is claimed is:

1. A method for simulating processor power consumption, the method comprising:
simulating a simulated processor by a simulation module;
utilizing a power analysis model to analyze said simulated processor's execution of at least one fragment of a program, for generating power analysis of a plurality of basic blocks of said at least one fragment by a analysis module;
computing at least one power correction factor between said plurality of basic blocks by a correction module;
utilizing a processing apparatus to generate a simulation model with power annotation based on said power analysis and said at least one power correction factor by a annotation module; and
predicting power consumption of said simulated processor based on said simulation model with power annotation by a prediction module.

2. The method according to claim 1, wherein said power analysis model is architecture level power analysis model.

3. The method according to claim 1, wherein said power correction factor comprises pipeline, branch, or cache miss power correction factor.

4. The method according to claim 1, further comprising a step of cross compilation, for generating target binary code.

5. The method according to claim 1, further comprising a step of power analysis utilizing breadth first search algorithm.

6. A storage medium readable by a processor, storing instructions executable by said processor to perform a method for simulating processor power consumption, said method comprising:
simulating a simulated processor by a simulation module;
utilizing a power analysis model to analyze said processor's execution of at least one fragment of a program, for generating power analysis of a plurality of basic blocks of said at least one fragment by a analysis module;
computing at least one power correction factor between said plurality of basic blocks by a correction module;
utilizing a processing apparatus to generate a simulation model with power annotation based on said power analysis and said at least one power correction factor by a annotation module; and
predicting power consumption of said simulated processor based on said simulation model with power annotation by a prediction module.

7. The storage medium according to claim 6, wherein said power analysis model is architecture level power analysis model.

8. The storage medium according to claim 6, wherein said power correction factor comprises pipeline, branch, or cache miss power correction factor.

9. The storage medium according to claim 6, wherein said method further comprises a step of cross compilation, for generating target binary code.

10. The storage medium according to claim 6, wherein said method further comprises a step of power analysis utilizing breadth first search algorithm.

11. A software product, tangibly embedded in a computer readable storage medium, for simulating processor power consumption, the software product comprising instructions operable to cause a processing apparatus to perform a method for
simulating processor power consumption, the method comprising:
simulating a simulated processor by a simulation module;
utilizing a power analysis model to analyze said simulated processor's execution of at least one fragment of a program, for generating power analysis of a plurality of basic blocks of said at least one fragment by a analysis module;
computing at least one power correction factor between said plurality of basic blocks by a correction module;
generating a simulation model with power annotation based on said power analysis and said at least one power correction factor by a annotation module; and
predicting power consumption of said simulated processor based on said simulation model with power annotation by a prediction module.

12. The software product according to claim 11, wherein said power analysis model is architecture level power analysis model.

13. The software product according to claim 11, wherein said power correction factor comprises pipeline, branch, or cache miss power correction factor.

14. The software product according to claim 11, further comprising instructions operable to cause said processing processor to perform a step of cross compilation, for generating target binary code.

15. The software product according to claim 11, further comprising instructions operable to cause said processing processor to perform a step of power analysis utilizing breadth first search algorithm.

16. A system for simulating processor power consumption, the system comprising:
a control module;
a simulation module, coupled to said control module, for simulating a simulated processor;
an analysis module, coupled to said control module, for utilizing a power analysis model to analyze said simulated processor's execution of at least one fragment of a target program and generate power analysis of a plurality of basic blocks of said at least one fragment;
a correction module, coupled to said control module, for computing at least one power correction factor between said plurality of basic blocks;
an annotation module, coupled to said control module, for generating a simulation model with power annotation based on said power analysis and said at least one power correction factor; and
a prediction module, coupled to said control module, for predicting power consumption of said simulated processor based on said simulation model with power annotation.

17. The system according to claim 16, wherein said power analysis model is architecture level power analysis model.

18. The system according to claim 16, wherein said correction module is configured to provide power correction factor of pipeline, branch, or cache miss.

19. The system according to claim 16, wherein said analysis model is configured to utilize a cross compiler to cross compile, for generating target binary code.

20. The system according to claim 16, wherein said analysis module is configured to utilize breadth first search algorithm for power analysis.
